(19) United States
(12) Patent Application Publication
(10) Pub. No.: US 2005/0067329 A1
(43) Pub. Date: Mar. 31, 2005

(54) Method for processing flat deliveries in delivery containers

(76) Inventors: Dietmar Oexle, Singen (DE); Rolf Peter Skrdlant, Konstanz (DE)

Correspondence Address: Philip G Meyers;Intellectual Property Law, 1009 Long Prarie Road, Suite 302, Flower Mound, TX, 75028, US

(21) Appl. No.: 10/497,295

(22) PCT Filed: Sep. 26, 2003
(86) PCT No.: PCT/DE03/03210

(30) Foreign Application Priority Data
Sep. 30, 2002 (DE) 102-45-873.1

(51) Int. Cl. B07C 5/00

(52) U.S. Cl. 209/584

(57) ABSTRACT

Method according to which deliveries (3), which have been sorted with the aid of a sorting installation (1), are transferred from end locations (2) into delivery containers (5). Said installation comprises intermediate storage compartments (4) in the end locations (2) for a respective delivery container (5), which receives the deliveries (3) of the respective end location (2). An element confirming the presence of a delivery container (5) is provided for each intermediate storage compartment (4). After the removal of a full delivery container (5) from the respective intermediate storage compartment (4), an empty delivery container (5) is introduced into said compartment (4) and a signal triggered by the confirmation element causes the identification reference (9) of the delivery container (5), which has previously been read by a read device (12), to be assigned to the target address or the target address zone, which has been assigned to this end location (2) by the current sorting plan, and to be stored.

The invention relates to a method for processing mail pieces according to the preamble of claim 1.

In the known sorting machine, trays without fixed identification marks are used. After the end of the sorting operation, the mail pieces are transferred from the sorting bins of the sorting machine into the trays which are provided in buffer storage units assigned to the sorting bins, and the concluded transfer operation is acknowledged for the respective sorting bin by means of key actuation. As a result, by means of a label printer, a label with the current destination address is printed out in coded and/or readable form for this sorting bin or with an identification label and is attached to the container by the operator. The requirement for an identification label automatically involves assignment between the identification label and the destination address, this assignment being filed in the control and being available for further identification. This solution does not allow the expedient use of trays with fixed identification marks in the mail handling process, since it is not possible for these identification marks to be coupled to the destination addresses on the basis of the abovementioned technology.

The object on which the invention is based is to provide a generic method, in which fixed identification marks of trays, into which the mail pieces are transferred from the sorting bins of the sorting machine, are assigned to the variable destination addresses of the sorting bins at low outlay and reliably, so that the identification marks can be utilized for further process steps after sorting, for example the automatic attachment of a label or tie-up to a tray management system.

The object is achieved, according to the invention, by means of a method having the features of claim 1.

For each buffer storage unit belonging to a sorting bin, a confirmation element for the presence of a tray is provided. After a filled tray has been discharged from the respective buffer storage unit and after the confirmation element has at the same time been reset to the empty state, an empty tray is reloaded into this buffer storage unit. As a result of a signal triggered in this case from the confirmation element, the identification mark belonging to the tray and previously read by a reading device is assigned to the destination address for the destination address area allocated to this sorting bin by the current sorting plan and is stored. By means of this procedure, the identification marks of the trays, for example in the form of RFID labels, are reliably assigned to the current destination addresses of the respective storing bin, without each storing bin needing to possess a reader for identification marks.

Advantageous refinements of the invention are presented in the subclaims.

Thus, it is advantageous if the reading device is blocked, after the reading of the identification mark, until the next confirmation signal relating to the presence of a tray is triggered. This prevents the situation where, when several operators use one reading device together, the correct assignment of the identification mark to the destination address is lost.

It is also advantageous to provide a confirmation element a presence sensor for trays in the buffer storage unit. A corresponding presence signal is thereby triggered automatically.

In a further design variant for confirmation elements, a switching element to be actuated by the operator is located at the buffer storage unit or at the assigned sorting bin. This ensures semiautomatic operation, in which case the operator can take into account the degree of filling of the tray in the supply and discharge of these.

Advantageously, the sorting machine also has a fully automatic or semiautomatic supply device for empty trays.

Advantageously, one or more supply stations equipped in each case with a reading device for the identification marks of the tray are provided for the empty trays. When the trays are supplied for the entire sorting machine or for specific areas, the reading of the respective identification marks also takes place. It is consequently possible to keep the walking distances of the operators short.

To ensure the reliable assignment of the identification marks even in the event of the change from one sorting run with an associated sorting plan to the next sorting run with an associated sorting plan, in a further advantageous refinement, after the last delivery of the previous sorting run has been sorted according to the associated sorting plan, for the mail pieces to be sorted in the next sorting run the sorting bins are assigned to the destination addresses according to the sorting plan of the next sorting run, so that, for example using separating cards, the next sorting run can be commenced without interruption. When all the mail pieces of an sorting bin of the previous sorting run are transferred, the tray for these mail pieces is removed from the buffer storage unit and a new empty tray for the mail pieces of the new sorting run is contained, after the reading of its identification mark, in the respective buffer storage unit, the corresponding switching element is actuated twice in succession, as a result of the first actuation the presence of the tray in the buffer storage unit being signaled, and as a result of the second actuation the change of the assignment of the identification mark to the new destination address taking place.

It is advantageous, furthermore, if, at each sorting bin, a signal generator is located, which is switched on by virtue of the correct actuation of the switching element during the loading of the buffer storage unit and is switched off automatically, by a presence sensor located in each buffer storage unit, during the removal of the tray from the buffer storage unit. The operator can thereby recognize the switching and assignment state and avoid errors.

The invention is explained in more detail below in an exemplary embodiment, with reference to the drawing in which:

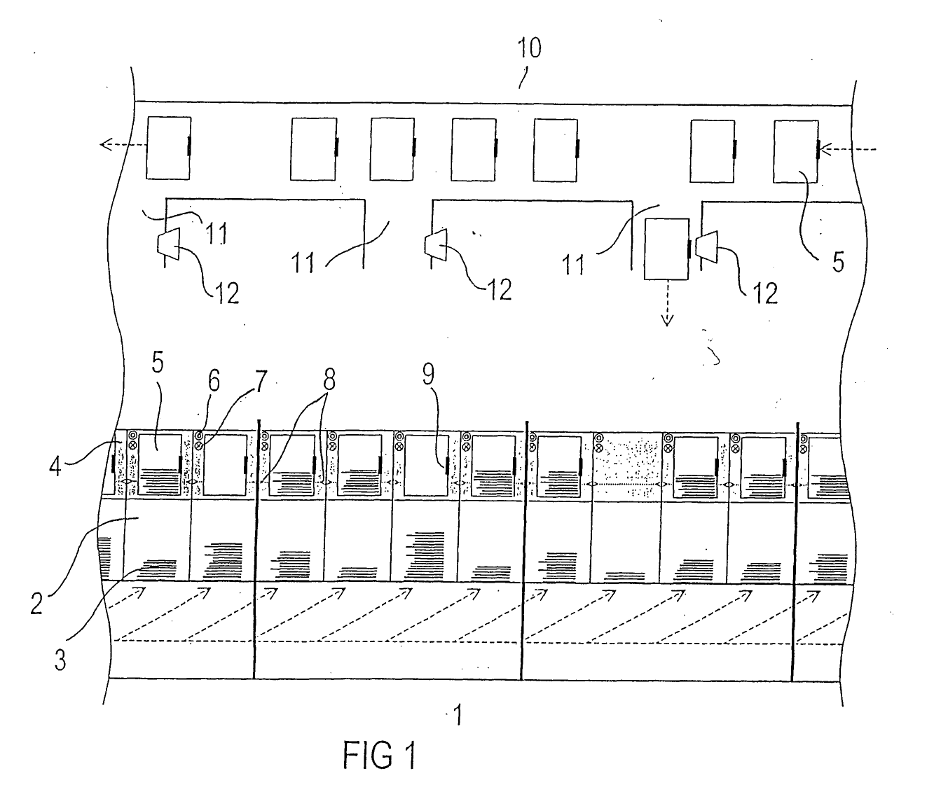

FIG. 1 shows a diagrammatic top view of a sorting machine.

As may be gathered from FIG. 1, located next to one another along a sorting machine 1 are sorting bins 2, into which the mail pieces 3 are sorted, standing on their narrow sides, according to destination addresses in conformity with a sorting plan. The sorting bins 2 are designed as sorting compartments, at the stacking point of which the mail pieces enter the stacking compartment and are held in the vertical position by a stack support, not illustrated, which can be displaced away from the stacking point according to the stack size counter to a spring force. Each sorting bin 2 has belonging to it a buffer storage unit 4 which receives a sorting bin 5 with a fixed identification mark 9 and into which the mail pieces 3 are transferred from this sorting bin 2 when the sorting bin 2 is correspondingly filled. The buffer storage units 4 are normally located below the sorting bin 2 and are drawn forward solely for the transfer operations and for re-equipping with trays 3, on telescopic rails into the position illustrated for all the sorting bins 2 in the drawing for a clearer explanation. Located in the region of each sorting bin 2 is a switching element 6 (designed as a key) and a signal generator 7, (designed as a luminous element) which indicates whether the switching element 6 has been properly actuated. Within the buffer storage unit 4 is arranged a presence sensor 8(designed as a light barrier) which detects whether a tray 5 is located in the buffer storage unit 2 or not. Arranged parallel to the sorting bin 2, at a distance which leaves sufficient space for the operators, is a supply device 10 for empty trays 5 with a plurality of supply stations 11. Each supply station 11 has a reading device 12 for the identification marks 9 of the trays 3. These identification marks 9 may be both optically readable bar codes and RFID tags.

The number of supply stations 11 is defined as a function of the number of sorting bin 2, in such a way that the operator or operators have to cover as short distances as possible. In this example, each supply station 11 with the reading device 12 is assigned an area with 4 sorting bins 2. A further reason for division is to safeguard the assignment of the read identification mark 9 and station 2 or the corresponding destination address. In order to guarantee this, the sorting bins and the associated reading devices 12 are also assigned to specific operators. In the case of overlapping assignments, that is to say two operators are competent for one area, after the reading of an identification mark 9, the reading device 12 is blocked until the next confirmation signal relating to the new presence of a tray 5 in a sorting bin 2 of this area is triggered.

During a sorting run, the mail pieces 3 are sorted into the sorting bins 2. Where a sorting bin 2 is approximately 2/3 full, the respective buffer storage unit 4 is drawn out, and the mail pieces 3 are transferred from the sorting bin 2 into the tray 5 in the buffer storage unit 4. The tray 5 is then removed. Triggered by the change of signal from the presence sensor 8, the signal generator/luminous element 7 is extinguished. The operator then extracts an empty tray 5 from the supply device 10 at the corresponding supply station 11, allows the identification mark 9 to be read by the reading device 12 and places said container into the empty buffer storage unit 4 in which the signal generator 7 signals no container absence. It subsequently actuates the switching element 6, with the result that the signal generator 7 emits a luminous signal again and at the same time the identification mark 9 of this tray 5 is assigned to the destination address which has been allocated to this sorting bin 2 by the active sorting plan.

In order to avoid unnecessary standstill times in the sorting machine 1, after the sorting of the last delivery 3 of the previous sorting run, separating cards are introduced into the sorting bin 2, said separating cards identifying the last delivery 3 in each sorting bin 2, and the next sorting run is commenced without interruption. For this purpose, a change from the destination addresses according to the sorting plan of the previous sorting run which were allocated to the sorting bins 2 to the destination addresses according to the sorting plan of the new sorting run takes place. However, this assignment change with respect to the identification marks 9 of the trays 5 for each sorting bin 2 is carried out only when all the mail pieces 3 of the previous sorting run at the sorting bin 2 have been transferred into a tray 5 and this tray 5 has been removed. After the new empty tray 5 has been extracted from the supply station 11 after the reading of the identification mark 9 and has been placed into the respective buffer storage unit 4, the respective switching element 6 is actuated twice in succession.

The first actuation signals the presence of the tray 5 just read in the buffer storage unit 4 and the second actuation results in the new allocation of this sorting bin 2 to the destination address according to the sorting plan of the new sorting run. This is carried out until all the sorting bins are worked through. When no delivery 3 has been sorted into a specific sorting bin 2 during a sorting run, the sorting bin 2 and associated tray 5 are empty. In this case, the signal generator 5 still lights up and the switching element 6 has to be actuated once only in order to carry out the change to the new sorting plan.

1. A method for processing mail pieces with the aid of a sorting machine, in which the sorted mail pieces are loaded from sorting bins of the sorting machine into trays transportable for the mail pieces, with a buffer storage unit at or below each sorting bin for holding of one tray, characterized in that, for each buffer storage unit a confirmation element for the presence of a tray is provided, in that, after a filled tray has been discharged from the respective buffer storage unit, an empty tray is reloaded into this buffer storage unit, and in that, as a result of a signal triggered in this case from the confirmation element, the identification mark, previously read by a reading device, of the tray is assigned to the destination address or the destination address area allocated to this sorting bin by the current sorting plan and is stored.

2. The method as claimed in claim 1, characterized in that the reading device is blocked, after the reading of the identification mark, until the next confirmation signal relating to the presence of a tray is triggered.

3. The method as claimed in claim 1, characterized in that, after the discharge of a filled tray from a buffer storage unit, the respective confirmation element is reset to the empty state.

4. The method as claimed in claim 1, characterized in that a presence sensor for trays is provided as confirmation element in the buffer storage unit.

5. The method as claimed in claim 1, characterized in that a switching element to be actuated by the operator is provided as confirmation element at the buffer storage unit or at the assigned sorting bin.

6. The method as claimed in claim 1, characterized in that the sorting machine possesses a supply device for empty trays.

7. The method as claimed in claim 1, characterized in that one or more supply stations assigned in each case to a specific sorting bin area and equipped in each case with a reading device for the identification marks of the trays are provided for the empty trays.

8. The method as claimed in claim 5, characterized in that, after the last delivery of the previous sorting run has been sorted according to the associated sorting plan, for the mail pieces of the next sorting run which are to be sorted, the sorting bins are allocated to the destination addresses according to the sorting plan of the next sorting run, and, when all the mail pieces of a sorting bin of the previous sorting run are transferred, the tray for these mail pieces is removed from the buffer storage unit and a new empty tray for the mail pieces of the new sorting run is contained, after the reading of its identification mark, in the respective buffer storage unit, and the corresponding switching element (is actuated twice in succession, as a result of the first actuation the presence of the tray just read in the buffer storage unit being signaled, and as a result of the second actuation the change of the assignment of the identification mark to the new destination address taking place.

9. The method as claimed in claim 5, characterized in that, at each sorting bin, a signal generator is located, which is switched on by virtue of the correct actuation of the switching element during the loading of the buffer storage unit and is switched off automatically, by a presence sensor located in each buffer storage unit, during the removal of the tray from the buffer storage unit.
